(19) United States
(12) Patent Application Publication
(10) Pub. No.: US 2025/0245970 A1
(43) Pub. Date: Jul. 31, 2025

(54) SYSTEMS AND METHODS FOR DETECTING AND TRACKING OBJECTS INCORPORATING LEARNED SIMILARITY

(71) Applicant: Toyota Jidosha Kabushiki Kaisha, Toyota-shi Aichi-ken (JP)

(72) Inventors: Charles C. Ochoa, San Francisco, CA (US); Anastasya Dubrovina Karni, Palo Alto, CA (US); Alexey Khuraskin, Palo Alto, CA (US); Kiril Vidimce, Kailua, HI (US)

(21) Appl. No.: 18/428,475

(22) Filed: Jan. 31, 2024

(51) Int. Cl. G06V 10/774; G05D 1/242; G05D 1/243; G05D 1/246; G05D 101/15; G06V 10/62; G06V 10/74; G06V 10/77; G06V 10/82

(52) U.S. Cl. CPC G06V 10/774; G05D 1/2435; G06V 10/62; G06V 10/761; G06V 10/7715; G06V 10/82; G05D 1/242; G05D 1/2465; G05D 2101/15

(57) ABSTRACT

Systems and methods described herein relate to detecting and tracking objects. In one embodiment, a system extracts first features from time-sequential perceptual sensor data to generate a first set of bird's-eye-view (BEV) feature images. The system also extracts second features from the first set of BEV feature images using a three-dimensional (3D) detection backbone to generate a second set of BEV feature images. The system also consumes the second set of BEV feature images using a neural-network 3D detection head that is trained with a similarity objective to support an object tracker for use in one of (1) controlling an autonomous robot and (2) generating automatically labeled perception data to train one or more of an online perception model, an online prediction model, and an online planning model used to control an autonomous robot.

### TECHNICAL FIELD

The subject matter described herein relates in general to robots and, more specifically, to systems and methods for detecting and tracking objects incorporating learned similarity.

### BACKGROUND

An important aspect of robotics, in particular autonomous robots, is “scene understanding,” in which objects and their relationships to one another are recognized in the context of a three-dimensional scene—in some applications in real time. Though a variety of machine-learning-based solutions have been published and developed, the performance of machine-learning models for scene understanding can still be improved in significant ways.

### SUMMARY

An example of a system for detecting and tracking objects is presented herein. The system comprises a processor and a memory storing machine-readable instructions that, when executed by the processor, cause the processor to extract first features from time-sequential perceptual sensor data to generate a first set of bird's-eye-view (BEV) feature images. The memory also stores machine-readable instructions that, when executed by the processor, cause the processor to extract second features from the first set of BEV feature images using a three-dimensional (3D) detection backbone to generate a second set of BEV feature images. Each BEV feature image in the second set of BEV feature images corresponds to a distinct time step in the time-sequential perceptual sensor data. The memory also stores machine-readable instructions that, when executed by the processor, cause the processor to consume the second set of BEV feature images using a neural-network 3D detection head that is trained with a similarity objective to support an object tracker for use in one of (1) controlling an autonomous robot and (2) generating automatically labeled perception data to train one or more of an online perception model, an online prediction model, and an online planning model used to control an autonomous robot.

Another embodiment is a non-transitory computer-readable medium for detecting and tracking objects and storing instructions that, when executed by a processor, cause the processor to extract first features from time-sequential perceptual sensor data to generate a first set of bird's-eye-view (BEV) feature images. The instructions also cause the processor to extract second features from the first set of BEV feature images using a three-dimensional (3D) detection backbone to generate a second set of BEV feature images. Each BEV feature image in the second set of BEV feature images corresponds to a distinct time step in the time-sequential perceptual sensor data. The instructions also cause the processor to consume the second set of BEV feature images using a neural-network 3D detection head that is trained with a similarity objective to support an object tracker for use in one of (1) controlling an autonomous robot and (2) generating automatically labeled perception data to train one or more of an online perception model, an online prediction model, and an online planning model used to control an autonomous robot.

Another embodiment is a method of detecting and tracking objects. The method comprises extracting first features from time-sequential perceptual sensor data to generate a first set of bird's-eye-view (BEV) feature images. The method also includes extracting second features from the first set of BEV feature images using a three-dimensional (3D) detection backbone to generate a second set of BEV feature images. Each BEV feature image in the second set of BEV feature images corresponds to a distinct time step in the time-sequential perceptual sensor data. The method also includes consuming the second set of BEV feature images using a neural-network 3D detection head that is trained with a similarity objective to support an object tracker for use in one of (1) controlling an autonomous robot and (2) generating automatically labeled perception data to train one or more of an online perception model, an online prediction model, and an online planning model used to control an autonomous robot.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates an overview system architecture that pertains to various embodiments of the invention.

FIG. 2 illustrates an architecture of a perception data generation system, in accordance with an illustrative embodiment of the invention labeled Embodiment 1.

FIG. 3 is a block diagram of a bird's-eye-view (BEV) feature extractor, in accordance with Embodiment 1.

FIG. 4 is another block diagram of a BEV feature extractor, in accordance with Embodiment 1.

FIG. 5 is a block diagram of a perception data generation system, in accordance with Embodiment 1.

FIG. 6 is a flowchart of a method of generating perception data, in accordance with Embodiment 1.

FIG. 7 illustrates an architecture of an object detection and tracking system, in accordance with another illustrative embodiment of the invention labeled Embodiment 2.

FIG. 8 is a diagram of a learned-similarity object-comparison process, in accordance with Embodiment 2.

FIG. 9 is a block diagram of an object detection and tracking system, in accordance with Embodiment 2.

FIG. 10 is a flowchart of a method of detecting and tracking objects in accordance with Embodiment 2.

To facilitate understanding, identical reference numerals have been used, wherever possible, to designate identical elements that are common to the figures. Additionally, elements of one or more embodiments may be advantageously adapted for utilization in other embodiments described herein.

### DETAILED DESCRIPTION

The various embodiments described herein reflect important advancements in scene understanding. In a first embodiment (hereinafter “Embodiment 1”) pertaining to generating automatically labeled perception data in an offline processing environment, a three-dimensional (3D) detection backbone processing a time sequence of raw perceptual sensor data aggregates temporal information bidirectionally in time at the feature level prior to object detection, unlike conventional detection backbones. This feature-level temporal aggregation integrates information from the past, present, and future because it operates in an offline processing environment and processes the entire time sequence of perceptual sensor data. For each time step in the time sequence of perceptual sensor data, the 3D detection backbone described herein produces a bird's-eye-view (BEV) feature image incorporating information from all time steps in the time sequence of perceptual sensor data. Applications for such a 3D detection backbone include, without limitation, (1) generating automatically labeled perception data for training online perception, prediction, and/or planning models used to control an autonomous robot and (2) validating the performance of a complete online “autonomous stack” (e.g., perception, prediction, and planning models) used to control an autonomous robot. The disclosed offline bidirectional 3D detection backbone provides significant advantages over conventional solutions, including higher accuracy in object detection and automatic labeling/annotation and greater temporal consistency and the ability to handle partially and fully occluded objects correctly.

In a second embodiment (hereinafter “Embodiment 2”), innovative object detection and tracking capabilities are added to a 3D detection backbone. In some variations, the 3D detection backbone is the offline bidirectional 3D detection backbone of Embodiment 1 discussed above, and applications focus on generating automatically labeled perception data to train various machine-learning models used to control an autonomous robot. In other variations, the 3D detection backbone is a causal (forward-recurrence-only) backbone, and applications focus on detecting and tracking objects in real time in connection with online control of an autonomous robot. Embodiment 2, instead of separately training a detector and a learned-similarity model, as in prior-art systems, trains a detector subject to a similarity objective to improve the performance of the detector and an associated object tracker. In a variation in which the 3D detection backbone is the offline bidirectional 3D detection backbone discussed above, global association is applied to object comparisons output by the 3D detector head to improve the robustness of the object tracker.

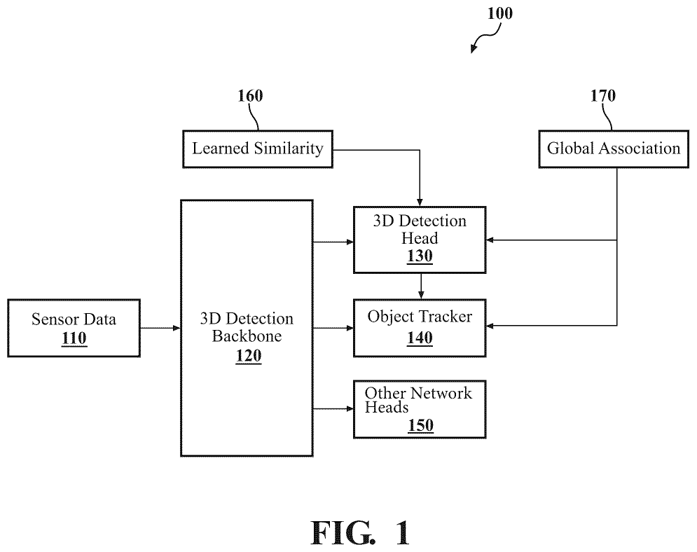

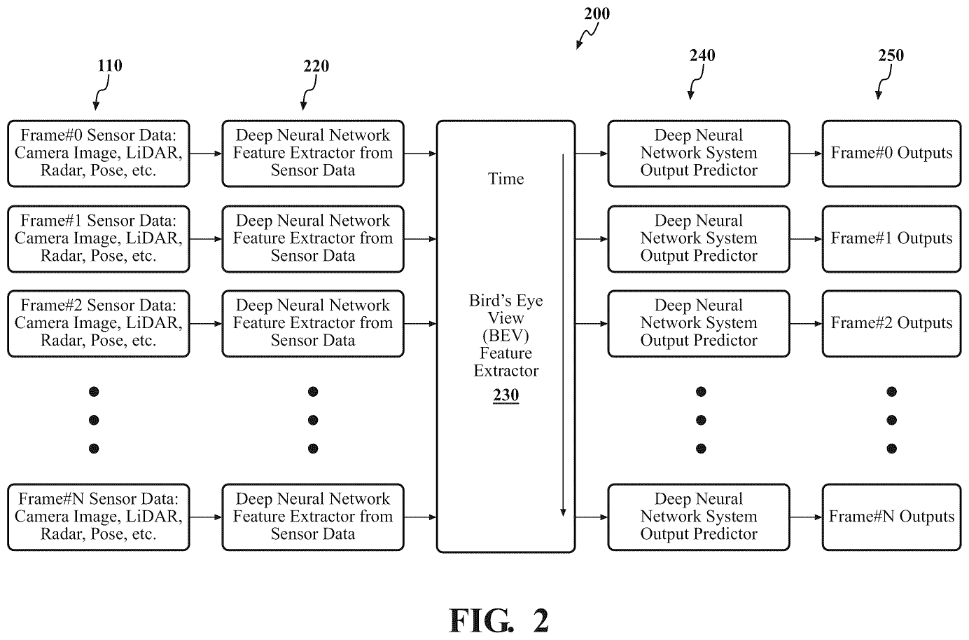

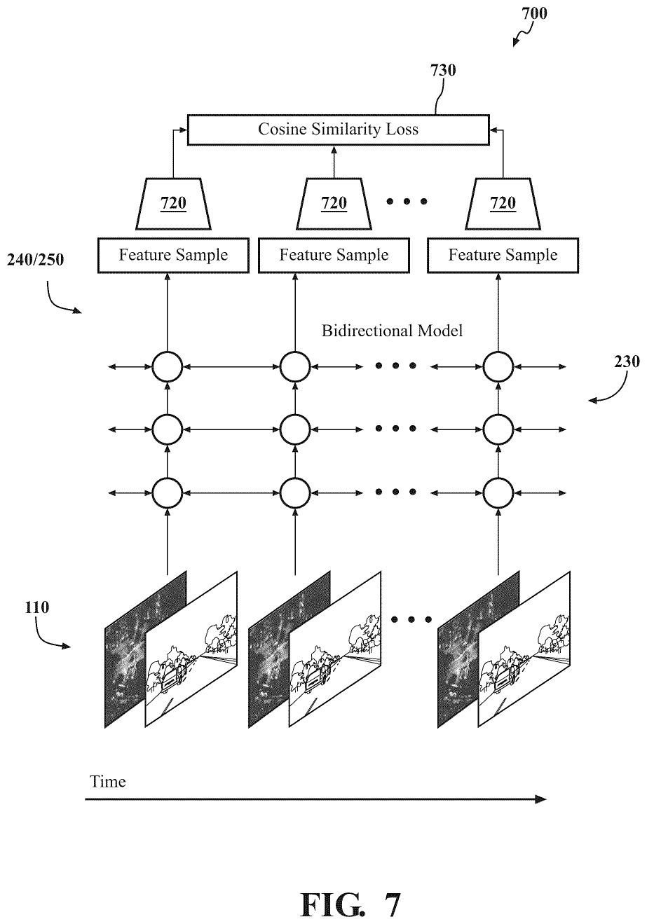

The remainder of this Detailed Description is organized as follows. First, a high-level overview of both Embodiment 1 and Embodiment 2 is provided via a discussion of FIG. 1. Second, Embodiment 1 is described in detail in connection with FIGS. 2-6. Third, Embodiment 2 is described in detail in connection with FIGS. 7-10. A conclusion then follows.

FIG. 1 illustrates an overview system architecture 100 that pertains to Embodiments 1 and 2 and to variations of those embodiments. In FIG. 1, sensor data 110 is input to a 3D detection backbone 120. In Embodiments 1 and 2 and variations thereof, the sensor data 110 includes one or more of the following types of sensor data: camera images, Light Detection and Ranging (LIDAR) data, radar data, sonar data, odometry data (e.g., Global-Positioning-System data combined with Inertial-Measurement-Unit data), map data, and audio data in a time-sequential (time-series) format. In implementations in which sensor data 110 includes more than one type of sensor data (e.g., images, LIDAR data, and radar data), the different types of sensor data are time-synchronized with one another and can be divided into frames, one frame for each discrete time step in the sensor data 110. The 3D detection backbone 120 includes one or more neural-network-based machine-learning models that extract features from the sensor data 110 to produce a set of BEV feature images, one BEV feature image for each time step in the sensor data 110. As discussed above, in some implementations, 3D detection backbone 120 is an offline bidirectional 3D detection backbone, as in Embodiment 1. In other embodiments, 3D detection backbone 120 is a causal (forward-recurrence-only) 3D detection backbone that can support online (real-time) object detection and tracking, as in some variations of Embodiment 2 discussed below.

In Embodiment 2, a 3D detection head 130 consumes (processes) the BEV feature images output by 3D detection backbone 120. The 3D detection head 130 is trained with a similarity objective (represented as “learned similarity 160” in FIG. 1) that improves the performance of 3D detection head 130 and that of an object tracker 140 supported by 3D detection head 130. In some variations employing an offline bidirectional 3D detection backbone, global association 170 is used to improve the robustness of object tracker 140, as explained further below. As indicated in FIG. 1, other network heads 150 can consume the BEV feature images output by 3D detection backbone 120. Examples of other network heads 150 include, without limitation, one or more heads that apply, to perception data output by the system, labels/annotations such as 3D cuboids enclosing detected objects, a 3D semantic-occupancy head, an occupancy-flow head, a map-elements head, an instance-segmentation head, a panoptic-segmentation head, a drivable-surface-estimation head, and an elevation-estimation head.

### Embodiment 1: An Offline Bidirectional 3D Detection Backbone and Applications

FIG. 2 illustrates an architecture 200 of a perception data generation system, in accordance with Embodiment 1. Some portions of architecture 200, Deep-Neural-Network (DNN) feature extractors 220 and BEV feature extractor 230, correspond to 3D detection backbone 120 in FIG. 1 discussed above. Architecture 200 is an offline embodiment, meaning that DNN feature extractors 220 and BEV feature extractor 230 collectively correspond to the offline bidirectional 3D detection backbone discussed above that integrates past, present, and future information at each time step. In other words, architecture 200 processes an entire time sequence of sensor data 110 in a non-causal manner.

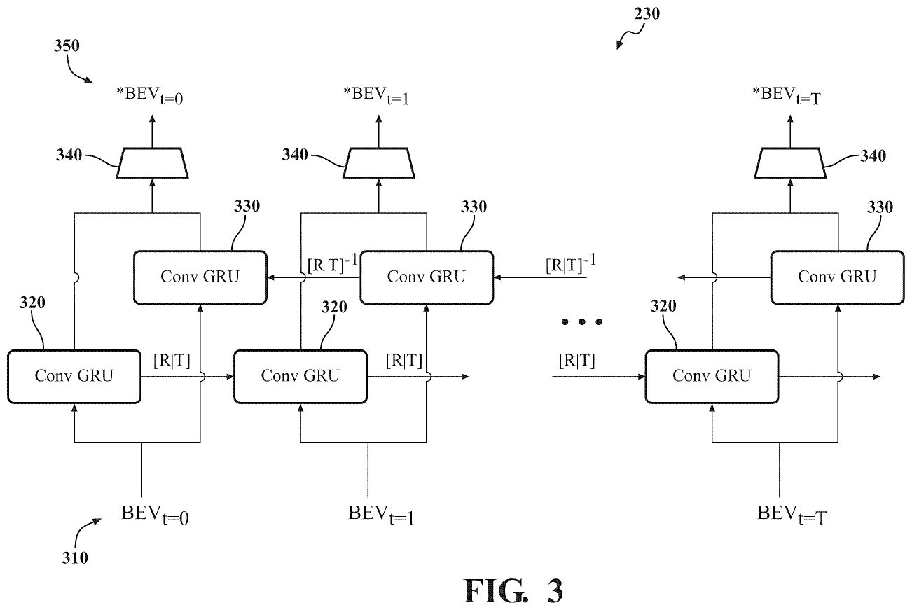

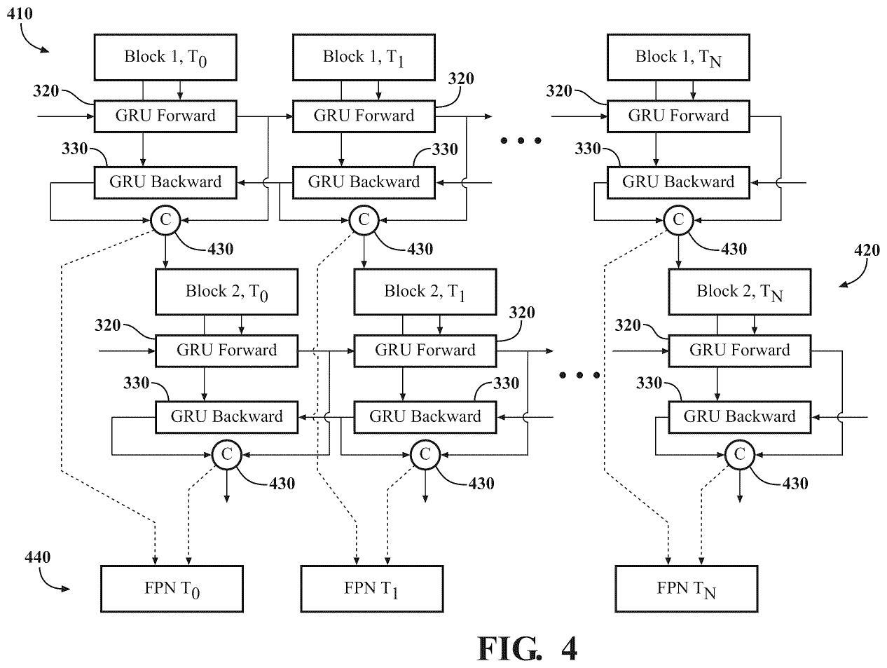

As shown in FIG. 2, sensor data 110 is divided into N+1 frames, one frame for each time step in the sensor data 110. As indicated, in FIG. 2 time increases in the downward direction. This being an offline embodiment, the N+1 frames represent a complete (entire) time sequence of perceptual sensor data stored by a computing system. For each frame of sensor data 110, architecture 200 includes a corresponding DNN feature extractor 220. The DNN feature extractors 220 extract features from the sensor data 110 to produce a set of N+1 initial BEV feature images (not shown in FIG. 2), one for each time step. BEV feature extractor 230 extracts features from the initial BEV feature images to produce a set of N+1 final BEV feature images (not shown in FIG. 2). Because of the bidirectional feature-level temporal aggregation that occurs in BEV feature extractor 230, each final BEV feature image incorporates information from all N+1 time steps in the time sequence of perceptual sensor data. This enhances the accuracy and temporal consistency of scene understanding. Additional details regarding BEV feature extractor 230 are provided below in connection with FIGS. 3 and 4.

As further shown in FIG. 2, a set of DNN system output predictors 240 consume the final BEV feature images produced by BEV feature extractor 230 to produce various system outputs 250. The DNN system output predictors 240 correspond to various neural-network heads. As discussed above, examples include a 3D detection head 130, one or more heads that apply, to perception data output by the system, labels/annotations such as 3D cuboids enclosing detected objects, a 3D semantic-occupancy head, an occupancy-flow head, a map-elements head, an instance-segmentation head, a panoptic-segmentation head, a drivable-surface-estimation head, and an elevation-estimation head. As those skilled in the art are aware, 3D information such as a 3D cuboid enclosing a detected object can be encoded in a BEV feature image.

FIG. 3 is a block diagram of a BEV feature extractor 230, in accordance with Embodiment 1. In FIG. 3, time increases from left to right. As shown in FIG. 3, the initial BEV feature images 310 are processed by a set of forward convolutional Gated Recurrent Units (GRUs) 320 (forward recurrence) and a set of backward convolutional GRUs 330 (backward recurrence). The forward convolutional GRUs 320 begin at the earliest time step and work forward in time, whereas the backward convolutional GRUs 330 begin at the latest time step in the data sequence and work backward in time. The forward and backward convolutional GRUs (320 and 330) extract additional features from the initial BEV feature images to produce, with the aid of additional neural networks 340, enhanced final BEV feature images 350 (marked in FIG. 3 with a leading asterisk to distinguish them from the input initial BEV feature images 310). As discussed above, each final BEV feature image 350 incorporates information from all time steps in the sequence of sensor data 110. The [R|T] and [R|T]⁻¹ notations in FIG. 3 denote matrix rotation and translation and inverse matrix rotation and translation operations in connection with the alignment of features between frames going forward and backward in time, respectively.

FIG. 4 is another block diagram of a BEV feature extractor 230, in accordance with Embodiment 1. Those skilled in the art will recognize that FIG. 4 depicts application of the high-level, bidirectional, temporal processing diagrammed in FIG. 3 to the blocks of the well-known U-Net architecture. In FIG. 4, time increases from left to right, as in FIG. 3. The system processes each level of a U-Net (Block 1 410 and then Block 2 420, in FIG. 4) completely both forward and backward in time for all time steps. That is, the system does not proceed downward from Block 1 410 to Block 2 420 until all processing at the Block-1 410 level has been completed. The combining operation 430 (“c”) in FIG. 4 combines (e.g., concatenates) the results at each level. The feature images are compressed further at each level (Block 1 410 and Block 2 420). The outputs of the Block 2 420 level are input to a set of Feature Pyramid Networks (FPNs) 440, which handle up-sampling. The FPNs 440 thus function as lightweight decoders. Notably, FIG. 4 diagrams in greater detail the bidirectional feature-level temporal aggregation discussed above that distinguishes Embodiment 1 from conventional 3D detection backbones.

In variations of Embodiment 1, the forward and backward GRUs are replaced by Long Short-Term Memory (LSTM) networks or transformer networks. These alternative network architectures can be used to perform the bidirectional feature-level temporal aggregation discussed above.

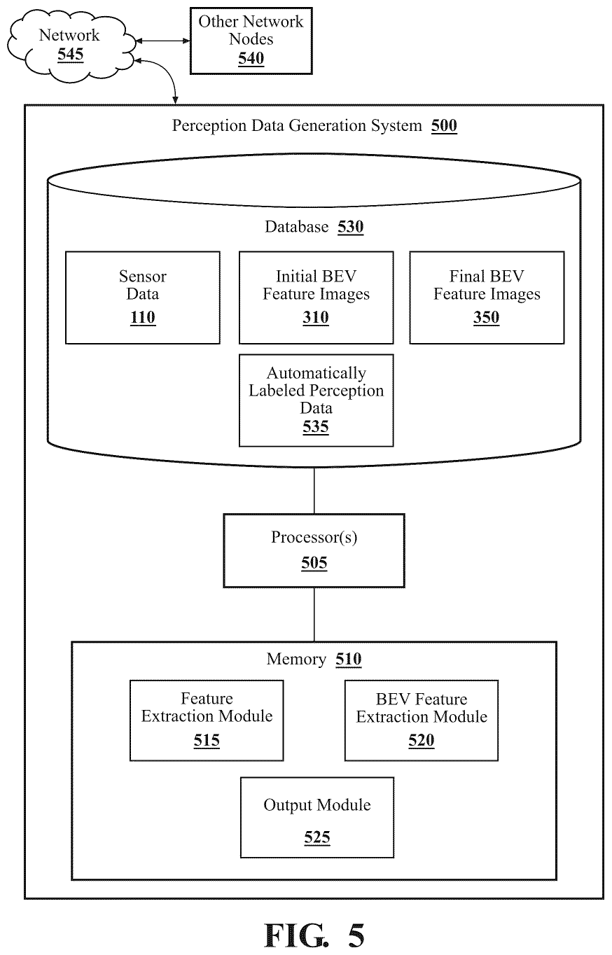

FIG. 5 is a block diagram of a perception data generation system 500, in accordance with Embodiment 1. In some variations, perception data generation system 500 is implemented in a computer workstation or server. In FIG. 5, perception data generation system 500 is shown as including one or more processors 505. Perception data generation system 500 also includes a memory 510 communicably coupled to the one or more processors 505. The memory 510 stores a feature extraction module 515, a BEV feature extraction module 520 and an output module 525. The memory 510 is a random-access memory (RAM), read-only memory (ROM), a hard-disk drive, a flash memory, or other suitable memory for storing the modules 515, 520, and 525. The modules 515, 520, and 525 are, for example, computer-readable instructions that, when executed by the one or more processors 505, cause the one or more processors 505 to perform the various functions disclosed herein.

In connection with its tasks, perception data generation system 500 can store various kinds of data in a database 530. For example, in the embodiment shown in FIG. 5, perception data generation system 500 stores, in database 530, sensor data 110, initial BEV feature images 310, final BEV feature images 350, and the automatically labeled perception data 535 that perception data generation system 500 produces, in some variations. As discussed above, the output (535) of perception data generation system 500 can be used for applications such as (1) training online perception, prediction, and/or planning models used to control autonomous robots and (2) validating the performance of a complete online “autonomous stack” (e.g., perception, prediction, and planning models) used to control autonomous robots. For example, in the training context, the automatically labeled perception data 535 can be used as ground-truth data for the supervised training of machine-learning-based models. In the performance-validation context, the actual output of an online autonomous stack deployed in an autonomous robot (e.g., an autonomous vehicle) can be compared with the automatically labeled perception data 535, the latter serving as a performance benchmark. The output of perception data generation system 500 can also be used to ascertain an upper bound on the performance of a robot perception system. Processing that includes past, present, and future data, as described above, is the “ideal” case, so an online perception system cannot exceed that.

As shown in FIG. 5, in some variations perception data generation system 500 can communicate with other network nodes 540 (servers, client computers, networked autonomous robots, etc.) via a network 545. In some embodiments, network 545 includes the Internet.

Feature extraction module 515 generally includes instructions that when executed by the one or more processors 505 cause the one or more processors 505 to extract first features from a time sequence of perceptual sensor data 110 to generate the first set of BEV feature images (initial BEV feature images 310) discussed above in connection with FIGS. 2 and 3.

BEV feature extraction module 520 generally includes instructions that when executed by the one or more processors 505 cause the one or more processors 505 to extract second features from the initial BEV feature images 310 using a BEV feature extractor 230 that performs feature-level temporal aggregation including both forward recurrence and backward recurrence to generate a second set of BEV feature images (final BEV feature images 350). As discussed above, each final BEV feature image 350 corresponds to a distinct time step in the time sequence of perceptual sensor data 110 and incorporates information from all time steps in the time sequence of perceptual sensor data 110. An illustrative implementation of BEV feature extractor 230 is discussed above in connection with FIGS. 3 and 4.

Output module 525 generally includes instructions that when executed by the one or more processors 505 cause the one or more processors 505 to consume the final BEV feature images 350 using one or more neural-network heads to perform either (1) generating automatically labeled perception data 535 to train an online perception model, an online prediction model, and/or an online planning model used to control an autonomous robot or (2) validating the performance of an online autonomous stack used to control an autonomous robot. In some applications of perception data generation system 500, the autonomous robot is an autonomous vehicle. In other applications, the autonomous robot is, without limitation, a search and rescue robot, a delivery robot, an aerial drone, or an indoor robot, including any of various kinds of humanoid robots.

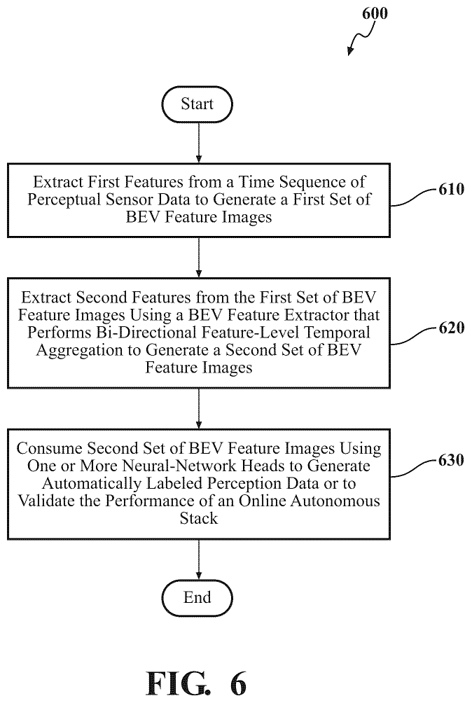

FIG. 6 is a flowchart of a method 600 of generating perception data, in accordance with Embodiment 1. Method 600 will be discussed from the perspective of perception data generation system 500 in FIG. 5. While method 600 is discussed in combination with perception data generation system 500, it should be appreciated that method 600 is not limited to being implemented within perception data generation system 500, but perception data generation system 500 is instead one example of a system that may implement method 600.

At block 610, feature extraction module 515 extracts first features from a time sequence of perceptual sensor data 110 to generate the first set of BEV feature images (initial BEV feature images 310) discussed above in connection with FIGS. 2 and 3. As explained above in connection with FIG. 2, this can be accomplished using a set of DNN feature extractors 220.

At block 620, BEV feature extraction module 520 extracts second features from the initial BEV feature images 310 using a BEV feature extractor 230 that performs feature-level temporal aggregation including both forward recurrence and backward recurrence to generate a second set of BEV feature images (final BEV feature images 350). Each final BEV feature image 350 corresponds to a distinct time step in the time sequence of perceptual sensor data 110 and incorporates information from all time steps in the time sequence of perceptual sensor data 110, as discussed above. The architecture and operation of BEV feature extractor 230 is discussed in greater detail above in connection with FIGS. 3 and 4.

At block 630, output module 525 consumes the final BEV feature images 350 using one or more neural-network heads to perform either (1) generating automatically labeled perception data 535 to train an online perception model, an online prediction model, and/or an online planning model used to control an autonomous robot or (2) validating the performance of an online autonomous stack used to control an autonomous robot. As discussed above, in some applications of perception data generation system 500, the autonomous robot is an autonomous vehicle. In other applications, the autonomous robot is, without limitation, a search and rescue robot, a delivery robot, an aerial drone, or an indoor robot, including any of various kinds of humanoid robots.

An offline bidirectional 3D detection backbone has been described above. Its output is directly useful for training perception, prediction, and planning models used to control an autonomous robot or for validating the performance of an entire autonomous stack used to control such a robot. The backbone described above can, in general, be used as a “black box” to support a variety of scene-understanding-related applications. One illustrative example of such an application is described in detail below in connection with Embodiment 2. However, as discussed below, there are variations of Embodiment 2 (object detection and tracking) in which the 3D detection backbone is causal (forward recurrence only) to support online object detection and tracking in an autonomous robot.

### Embodiment 2: Object Detection and Tracking

FIG. 7 illustrates an architecture 700 of an object detection and tracking system, in accordance with Embodiment 2. In FIG. 7, time increases from left to right, and a time sequence of sensor data 110 is input to a “Bidirectional Model” like that described above in connection with FIG. 2. That is, the particular variation of Embodiment 2 shown in FIG. 7 is based on the offline bidirectional 3D detection backbone discussed above in connection with Embodiment 1. In FIG. 7, the bottom row of circles corresponds to Block 1 410 in FIG. 4, and the next row up corresponds to Block 2 420, and so forth. The horizontal arrows pointing right and left represent information being passed forward (to the right) and backward (to the left) in time. As one moves upward from block to block, the resolution of the BEV feature images decreases. However, FIG. 7 does not show the FPNs that up-sample the BEV features (refer to the discussion of FIG. 4 above). Thus, in some embodiments, the final BEV feature images 350 are lower in resolution than the initial BEV feature images 310, and in other embodiments they are not necessarily lower in resolution. The final upward-pointing arrows (labeled “240/250” in FIG. 7) correspond, during training, to the DNN system output predictors 240 and, during inference, to both the DNN system output predictors 240 and the system outputs 250.

The system depicted in FIG. 7 samples features from 3D-cuboid locations (the locations of detected objects) in the final BEV feature images 350 (refer to FIG. 3 above) for the respective time steps. During training, the locations from which the features are sampled are ground-truth cuboid locations based on annotations added to the sensor data 110 by a human annotator or by some other method (e.g., an auto-labeler). During inference, these locations are the cuboid locations the model itself predicts.

In connection with the sampling of features from the final BEV feature images 350, a region-of-interest-alignment operation is used in some variations of Embodiment 2. Regarding the sampling of features at a given cuboid location, points can, for example, be sampled using nearest-neighbor interpolation, bilinear interpolation, or trilinear interpolation. Points can, for example, be sampled from the center of the cuboid, from the corners, or at regular intervals inside the cuboid. Points can be used from inside the rotated cuboid, from the surrounding region, or from an axis-aligned 2D BEV projection (minimum enclosing 2D box). The features from each point can be averaged or stacked (in some variations, in accordance with a predetermined order). In one variation of Embodiment 2, the system employs bilinear interpolation with points drawn from regular intervals inside the 2D axis-aligned BEV projection box, and all these points' features are averaged.

The feature samples 710 are processed per time step by a set of small Multilayer Perceptrons (MLPs) 720, which refine the sampled features (710). As shown in FIG. 7, a pairwise cosine-similarity loss 730 is computed based on the refined features. That is, a cosine-similarity loss 730 is computed between the features of pairs of object instances in the same frame or in different frames. In some variations, this cosine-similarity loss is applied up to a margin. That is, once features are far enough apart in feature space, the system stops paying the loss. The cosine-similarity loss 730 is one example of a way to apply a similarity objective to the training of the 3D detection head 130. In variations of Embodiment 2, other distance/similarity measures can be used in applying the similarity objective to the training of the detector. This process corresponds to the “learned similarity 160” mentioned in connection with FIG. 1.

In some variations of Embodiment 2, a predetermined limit is placed on the number of agents (cuboids with assigned track IDs) per time step whose features are sampled to limit the combinatorial number of pairwise feature comparisons that must be made. For example, in one variation, that predetermined limit is 15 cuboids per time step. In variations employing this limitation, meaningful (interesting, challenging) cuboids are chosen based on a preference for (1) “positive” samples (i.e., once an agent is chosen in one timestep, the probability of choosing the same agent is increased), (2) “challenging” samples (i.e., objects that are near one another; thus, once an agent has been selected, the probability of sampling other agents near that agent in the same or other time steps is increased), and (3) “similar” samples associated with objects of the same class (i.e., if a “person” agent is sampled, the probability of sampling other “person” agents is increased).

During training, the refined features are supervised by a contrastive optimization objective to achieve the learned similarity 160 discussed above. For example, in one variation of Embodiment 2, the contrastive objective is as follows: (1) minimize the cosine distance between features from the same agent and (2) maximize the cosine distance between features from different agents. This learned-similarity training process enables the system to recognize that two instances of the same agent in different frames are one and the same agent while, at the same time, recognizing that two different agents are not the same, despite their being in the same object classification (e.g., “vehicle”). For example, through learned similarity 160, the system can distinguish a Honda Civic from a Toyota Corolla even though each object is semantically classified as a “vehicle.” The trained system is also capable of recognizing that the front of a vehicle seen in one frame is the same vehicle seen from the rear in a later frame because the vehicle made a U-turn.

Consider two boxes b₁ and b₂ with different features f₁ and f₂ sampled at time steps t₁ and t₂ and corresponding feature vectors k₁ and k₂. The similarity between the two sets of sampled features can be defined as the probability that the two boxes b₁ and b₂ and are the same:

$$P = \frac{1}{\sqrt{2 π {σ}^{2}}} {e}^{\frac{- {d}^{2}}{2 {σ}^{2}}} ,$$

where

$$d = 1 - \frac{{k}_{1} \cdot {k}_{2}}{‖ {k}_{1} ‖ ‖ {k}_{2} ‖} ,$$

the cosine distance. The standard deviation σ of the probability distribution is a parameter that can be tuned by the system. The result of the dot product and normalization defining d is a value between −1 and 1. In one variation, the graph weight is a negative log probability scaled by a large, fixed constant for implementation reasons. The probability of a missed detection (the probability of seeing an object at time t₁ and then missing every detection of that object until time t₂ can be expressed as Pₘ=r^{((t}^{₂}^{-t}^{₁}⁾⁻¹⁾, where r is the missed-detection rate. In some variations, object pairs are ignored that are farther apart than dₘₐₓ(t₂−t₁). In those variations, the standard deviation σ is scaled in the above calculations as σ=dₘₐₓ\sqrt{t₂−t₁}.

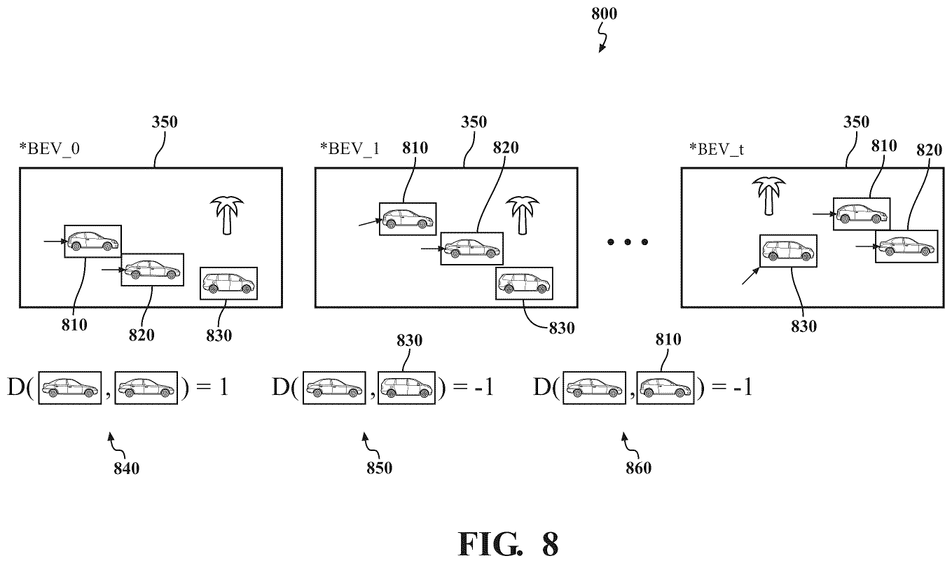

FIG. 8 is a diagram of a learned-similarity object-comparison process 800, in accordance with Embodiment 2. In FIG. 8, from *BEV_0 (a final BEV feature image 350) to *BEV_1 (the next final BEV feature image 350), vehicle 810 and vehicle 820 moved, but vehicle 830 stayed in the same place (i.e., vehicle 830 is stopped). From *BEV_1 to *BEV_t, all three vehicles have moved somewhat. The “D( )” operator in FIG. 8 measures the pairwise similarity (inversely related to the cosine-distance metric discussed above), in feature space, between two detected objects. Notice that the similarity between vehicle 820 in *BEV_0 and vehicle 820 in *BEV_1 is unity (comparison 840), the maximum similarity (i.e., they are determined to be one and the same object). In contrast, the comparisons of vehicle 820 with vehicle 810 and vehicle 830 (comparisons 850 and 860) yield the smallest possible dot product, −1 (i.e., they are determined to be different objects). In this context, the dot product is between the features of the first object and those of the second object. This process can be repeated for all combinations of two objects in the scene or for an intelligently selected subset of the possible pairs, depending on the particular variation of Embodiment 2.

In some offline variations of Embodiment 2 such as that depicted in FIG. 7 (bidirectional 3D detection backbone), the known technique of global association is combined with learned similarity to further improve the robustness of object tracker 140. Graph-based global data association is described in well-known publications such as L. Zhang et al., “Global Data Association for Multi-Object Tracking Using Network Flows,” Proceedings of the 2008 IEEE Conference on Computer Vision and Pattern Recognition, 2008, IEEE. Global association can correct errors that occur with learned similarity. For example, if learned similarity is incorrect for one time step, global association can correct the error because global association finds the globally optimum solution—over the entire sequence of sensor data 110. It should also be noted that since the feature vectors k₁ and k₂ discussed above encode object motion, the variations of Embodiment 2 that incorporate global association account for object motion in the globally optimum solution.

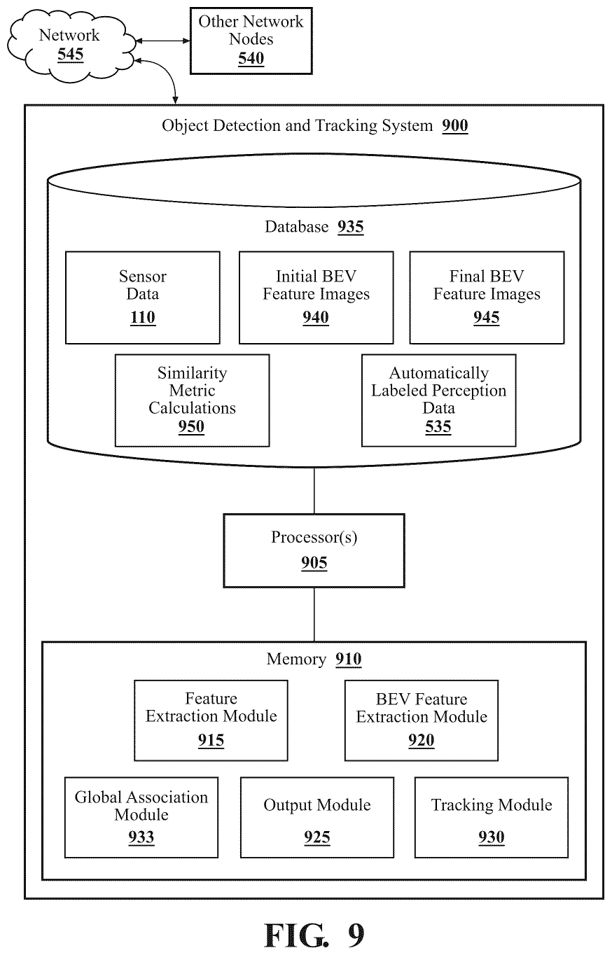

FIG. 9 is a block diagram of an object detection and tracking system 900, in accordance with Embodiment 2. In some offline variations of Embodiment 2 such as that depicted in FIG. 7, object detection and tracking system 900 is implemented in a computer workstation or server. In variations in which the 3D detection backbone is causal (forward recurrence only), object detection and tracking system 900 can be implemented as an online system in an autonomous robot.

Object detection and tracking system 900 is shown as including one or more processors 905. Object detection and tracking system 900 also includes a memory 910 communicably coupled to the one or more processors 905. The memory 910 stores a feature extraction module 915, a BEV feature extraction module 920, an output module 925, a tracking module 930, and a global association module 933. The memory 910 is a random-access memory (RAM), read-only memory (ROM), a hard-disk drive, a flash memory, or other suitable memory for storing the modules 915, 920, 925, 930, and 933. The modules 915, 920, 925, 930, and 933 are, for example, computer-readable instructions that when executed by the one or more processors 905, cause the one or more processors 905 to perform the various functions disclosed herein.

In connection with its tasks, object detection and tracking system 900 can store various kinds of data in a database 935. For example, in the embodiment shown in FIG. 9, object detection and tracking system 900 stores, in database 935, sensor data 110, initial BEV feature images 940, final BEV feature images 945, similarity metric calculations 950, and automatically labeled perception data 535. Similarity metric calculations 950 can include calculations relating to cosine distance, similarity probability, etc.

As shown in FIG. 9, object detection and tracking system 900 can communicate with other network nodes 540 (client computers, servers, autonomous robots, etc.) via a network 545. In some embodiments, network 545 includes the Internet.

Feature extraction module 915 generally includes instructions that when executed by the one or more processors 905 cause the one or more processors 905 to extract first features from time-sequential perceptual sensor data 110 to generate a first set of BEV feature images. In offline variations of Embodiment 2, the first set of BEV feature images corresponds to initial BEV feature images 310 discussed above in connection with FIGS. 2 and 3. As discussed above, the 3D detection backbone can be of the offline type depicted in FIGS. 2-4 and 7, or, in other variations, it can be a causal (forward-recurrence-only) 3D detection backbone. In either type of variation, feature extraction module 915 extracts a first set of features from sensor data 110 and generates a first set of BEV feature images.

BEV feature extraction module 920 generally includes instructions that when executed by the one or more processors 905 cause the one or more processors 905 to extract second features from the first set of BEV feature images using a 3D detection backbone 120 to generate a second set of BEV feature images (e.g., final BEV feature images 350, in offline variations of Embodiment 2). Each BEV feature image in the second set of BEV feature images corresponds to a distinct time step in the time-sequential perceptual sensor data 110. As discussed above, the 3D detection backbone 120 can be of the offline type depicted in FIGS. 2-4 and 7, or, in other variations, it can be a causal (forward-recurrence-only) 3D detection backbone. In either type of variation, BEV feature extraction module 920 extracts features from an initial (first) set of BEV images generated by feature extraction module 915.

Output module 925 generally includes instructions that when executed by the one or more processors 905 cause the one or more processors 905 to consume the second set of BEV feature images (e.g., final BEV feature images 350) using a neural-network 3D detection head 130 that is trained with a similarity objective to support an object tracker 140 (see tracking module 930 in FIG. 9) for use in one of (1) controlling an autonomous robot and (2) generating automatically labeled perception data 535 to train one or more of an online perception model, an online prediction model, and an online planning model used to control an autonomous robot. In some variations of object detection and tracking system 900, the autonomous robot is an autonomous vehicle. In other applications, the autonomous robot is, without limitation, a search and rescue robot, a delivery robot, an aerial drone, or an indoor robot, including any of various kinds of humanoid robots.

Tracking module 930 generally includes instructions that when executed by the one or more processors 905 cause the one or more processors 905 to track one or more objects in a scene over a sequence of frames to implement object tracker 140. As discussed above, this tracking can be supported by a 3D detection head 130 trained with a similarity objective (learned similarity).

Global association module 933 (applicable to offline variations of Embodiment 2 only) generally includes instructions that when executed by the one or more processors 905 cause the one or more processors 905 to improve the robustness of the object tracker 140 by applying global association to object comparisons output by the 3D detector head 130, as discussed above.

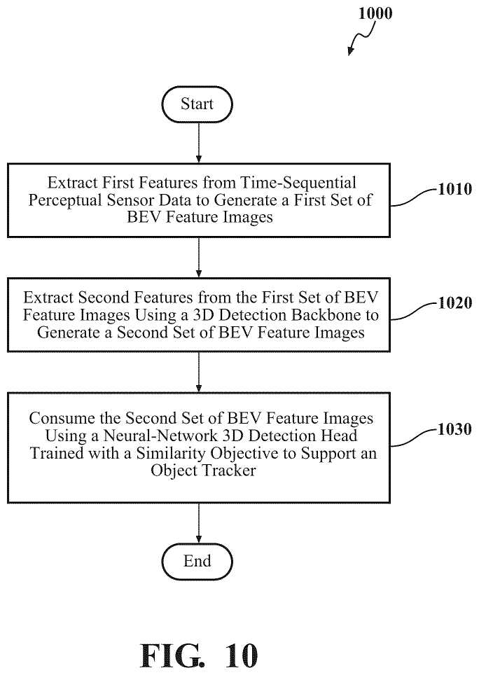

FIG. 10 is a flowchart of a method 1000 of detecting and tracking objects, in accordance with Embodiment 2. Method 1000 will be discussed from the perspective of object detection and tracking system 900 in FIG. 9. While method 1000 is discussed in combination with object detection and tracking system 900, it should be appreciated that method 1000 is not limited to being implemented within object detection and tracking system 900, but object detection and tracking system 900 is instead one example of a system that may implement method 1000. Also, method 1000 applies some of the same techniques described above in connection with Embodiment 1, particularly with regard to the 3D detection backbone whose output supports object detection and tracking.

At block 1010, feature extraction module 915 extracts first features from time-sequential perceptual sensor data 110 to generate a first set of BEV feature images. As discussed above, in offline variations of Embodiment 2, the first set of BEV feature images corresponds to initial BEV feature images 310 discussed above in connection with FIGS. 2 and 3. As also discussed above, the 3D detection backbone 120 can be of the offline type depicted in FIGS. 2-4 and 7, or, in other variations, it can be a causal (forward-recurrence-only) 3D detection backbone. In either type of variation, feature extraction module 915 extracts a first set of features from sensor data 110 to generate a first set of BEV feature images.

At block 1020, BEV feature extraction module 920 extracts second features from the first set of BEV feature images using a 3D detection backbone 120 to generate a second set of BEV feature images. Each BEV feature image in the second set of BEV feature images corresponds to a distinct time step in the time-sequential perceptual sensor data 110. As discussed above, in offline variations of Embodiment 2, the second set of BEV feature images corresponds to final BEV feature images 350 (see FIG. 3). The 3D detection backbone 120 can be of the offline type depicted in FIGS. 2-4 and 7, or, in other variations of Embodiment 2, it can be a causal (forward-recurrence-only) 3D detection backbone. In either type of variation, BEV feature extraction module 920 extracts features from an initial (first) set of BEV images generated by feature extraction module 915 and generates a second (enhanced) set of BEV feature images.

At block 1030, output module 925 consumes the second set of BEV feature images (e.g., final BEV feature images 350, in offline variations) using a neural-network 3D detection head 130 that is trained with a similarity objective to support an object tracker 140 (refer to tracking module 930 in FIG. 9) for use in one of (1) controlling an autonomous robot and (2) generating automatically labeled perception data 535 to train one or more of an online perception model, an online prediction model, and an online planning model used to control an autonomous robot. In some variations of object detection and tracking system 900, the autonomous robot is an autonomous vehicle. In other applications, the autonomous robot is, without limitation, a search and rescue robot, a delivery robot, an aerial drone, or an indoor robot, including any of various kinds of humanoid robots.

In some offline variations of method 1000, Global association module 933 improves the robustness of the object tracker 140 (refer to tracking module 930 in FIG. 9) by applying global association 170 to object comparisons output by the 3D detector head 130, as discussed above. For example, if learned similarity is incorrect for one time step, global association 170 can correct the error because global association 170 finds the globally optimum solution-over the entire sequence of sensor data 110.

### CONCLUSION

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-10, but the embodiments are not limited to the illustrated structure or application.

The flowcharts and block diagrams in the figures illustrate the architecture, functionality, and operation of possible implementations of systems, methods and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Generally, “module,” as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g. AB, AC, BC or ABC).

Aspects herein can be embodied in other forms without departing from the spirit or essential attributes thereof. Accordingly, reference should be made to the following claims rather than to the foregoing specification, as indicating the scope hereof.

What is claimed is:

1. A system for detecting and tracking objects, the system comprising:
a processor; and
a memory storing machine-readable instructions that, when executed by the processor, cause the processor to:
extract first features from time-sequential perceptual sensor data to generate a first set of bird's-eye-view (BEV) feature images;
extract second features from the first set of BEV feature images using a three-dimensional (3D) detection backbone to generate a second set of BEV feature images, wherein each BEV feature image in the second set of BEV feature images corresponds to a distinct time step in the time-sequential perceptual sensor data; and
consume the second set of BEV feature images using a neural-network 3D detection head that is trained with a similarity objective to support an object tracker for use in one of:
controlling an autonomous robot; and
generating automatically labeled perception data to train one or more of an online perception model, an online prediction model, and an online planning model used to control an autonomous robot.

2. The system of claim 1, wherein, in connection with generating the automatically labeled perception data, the 3D detection backbone, in processing the first set of BEV feature images in an offline processing environment, performs feature-level temporal aggregation that includes both forward recurrence and backward recurrence to generate the second set of BEV feature images and each BEV feature image in the second set of BEV feature images incorporates information from all time steps in the time-sequential perceptual sensor data.

3. The system of claim 2, wherein the machine-readable instructions include further instructions that, when executed by the processor, cause the processor to improve robustness of the object tracker by applying global association to object comparisons output by the 3D detector head.

4. The system of claim 1, wherein, in connection with controlling the autonomous robot in an online processing environment of the autonomous robot, the 3D detection backbone, in processing the first set of BEV feature images, performs feature-level temporal aggregation that includes forward recurrence to generate the second set of BEV feature images.

5. The system of claim 1, wherein the similarity objective includes a cosine-similarity loss.

6. The system of claim 1, wherein the time-sequential perceptual sensor data includes one or more of camera images, Light Detection and Ranging (LIDAR) data, radar data, sonar data, map data, and audio data.

7. The system of claim 1, wherein the autonomous robot is one of an autonomous vehicle, a search and rescue robot, a delivery robot, an aerial drone, and an indoor robot.

8. A non-transitory computer-readable medium for detecting and tracking objects and storing instructions that, when executed by a processor, cause the processor to:
extract first features from time-sequential perceptual sensor data to generate a first set of bird's-eye-view (BEV) feature images;
extract second features from the first set of BEV feature images using a three-dimensional (3D) detection backbone to generate a second set of BEV feature images, wherein each BEV feature image in the second set of BEV feature images corresponds to a distinct time step in the time-sequential perceptual sensor data; and
consume the second set of BEV feature images using a neural-network 3D detection head that is trained with a similarity objective to support an object tracker for use in one of:
controlling an autonomous robot; and
generating automatically labeled perception data to train one or more of an online perception model, an online prediction model, and an online planning model used to control an autonomous robot.

9. The non-transitory computer-readable medium of claim 8, wherein, in connection with generating the automatically labeled perception data, the 3D detection backbone, in processing the first set of BEV feature images in an offline processing environment, performs feature-level temporal aggregation that includes both forward recurrence and backward recurrence to generate the second set of BEV feature images and each BEV feature image in the second set of BEV feature images incorporates information from all time steps in the time-sequential perceptual sensor data.

10. The non-transitory computer-readable medium of claim 9, wherein the instructions include further instructions that, when executed by the processor, cause the processor to improve robustness of the object tracker by applying global association to object comparisons output by the 3D detector head.

11. The non-transitory computer-readable medium of claim 8, wherein, in connection with controlling the autonomous robot in an online processing environment of the autonomous robot, the 3D detection backbone, in processing the first set of BEV feature images, performs feature-level temporal aggregation that includes forward recurrence to generate the second set of BEV feature images.

12. The non-transitory computer-readable medium of claim 8, wherein the similarity objective includes a cosine-similarity loss.

13. The non-transitory computer-readable medium of claim 8, wherein the autonomous robot is one of an autonomous vehicle, a search and rescue robot, a delivery robot, an aerial drone, and an indoor robot.

14. A method, comprising:
extracting first features from time-sequential perceptual sensor data to generate a first set of bird's-eye-view (BEV) feature images;
extracting second features from the first set of BEV feature images using a three-dimensional (3D) detection backbone to generate a second set of BEV feature images, wherein each BEV feature image in the second set of BEV feature images corresponds to a distinct time step in the time-sequential perceptual sensor data; and
consuming the second set of BEV feature images using a neural-network 3D detection head that is trained with a similarity objective to support an object tracker for use in one of:
controlling an autonomous robot; and
generating automatically labeled perception data to train one or more of an online perception model, an online prediction model, and an online planning model used to control an autonomous robot.

15. The method of claim 14, wherein, in connection with generating the automatically labeled perception data, the 3D detection backbone, in processing the first set of BEV feature images in an offline processing environment, performs feature-level temporal aggregation that includes both forward recurrence and backward recurrence to generate the second set of BEV feature images and each BEV feature image in the second set of BEV feature images incorporates information from all time steps in the time-sequential perceptual sensor data.

16. The method of claim 15, further comprising improving robustness of the object tracker by applying global association to object comparisons output by the 3D detector head.

17. The method of claim 14, wherein, in connection with controlling the autonomous robot in an online processing environment of the autonomous robot, the 3D detection backbone, in processing the first set of BEV feature images, performs feature-level temporal aggregation that includes forward recurrence to generate the second set of BEV feature images.

18. The method of claim 14, wherein the similarity objective includes a cosine-similarity loss.

19. The method of claim 14, wherein the time-sequential perceptual sensor data includes one or more of camera images, Light Detection and Ranging (LIDAR) data, radar data, sonar data, map data, and audio data.

20. The method of claim 14, wherein the autonomous robot is one of an autonomous vehicle, a search and rescue robot, a delivery robot, an aerial drone, and an indoor robot.
